(19) United States
(12) Patent Application Publication
(10) Pub. No.: US 2013/0220381 A1
(43) Pub. Date: Aug. 29, 2013

(54) LINING MATERIAL REMOVAL SYSTEM AND METHOD

(71) Applicants: Gerard J. MacNeil, Surrey (CA); David B. MacNeil, Surrey (CA)

(72) Inventors: Gerard J. MacNeil, Surrey (CA); David B. MacNeil, Surrey (CA)

(21) Appl. No.: 13/861,770

(22) Filed: Apr. 12, 2013

Related U.S. Application Data
(63) Continuation-in-part of application No. 13/273,082, filed on Oct. 13, 2011.
(60) Provisional application No. 61/392,849, filed on Oct. 13, 2010.

(51) Int. Cl. B08B 9/043

(52) U.S. Cl. CPC B08B 9/0433
USPC 134/22.12; 134/167 C

(57) ABSTRACT

Apparatus for removing lining material from the inside of a cylindrical structure comprising a traveler received within the structure and movable along its length and having a securing means, a rotatable nozzle assembly connected to the traveler, the nozzle assembly comprising one or more nozzle lines each terminating in a nozzle head that rotates, the nozzle assembly being configured in a manner that each nozzle head is suitably spaced from the lining material to be able to deliver a jet of fluid under pressure to the lining material, a nozzle rotation means for rotating the nozzle assembly, and a conduit means in fluid communication with the nozzle assembly suitable for delivering a flow of fluid to the nozzle assembly under sufficient pressure to cut the lining material in the structure. A method employing the apparatus for removing lining material.

### RELATED APPLICATIONS

The present application is a continuation in part of U.S. application Ser. No. 13/273,082 filed Oct. 13, 2011, incorporated herein by reference, claiming priority benefit of U.S. Provisional Application No. 61/392,849 filed Oct. 13, 2010.

### BACKGROUND OF THE INVENTION

1. Field of the Invention

The field of the invention is hydro-demolition devices and methods for removing lining material from lined structures.

2. Background

Hydro-demolition—or hydraulic demolition—is a well known art practiced by forcing an erosive material, generally a liquid such as water, through nozzles at sufficiently high pressure to produce a jet stream that disintegrates the constituent building material, normally concrete, of which buildings and structures are made.

The term “lining material” as used herein refers to material provided on the inside surface of a structure, in one or more layers, and which may be removed by hydro-demolition techniques. The term “lined structure” refers to a pipe or other structure having an inside surface with lining material.

The terms “cut,” “cutting,” and “cutter,” etc. as used herein refer to the use of hydro-demolition technology to remove lining material from the inside of a lined structure.

The use of various materials to line conduits such as pipelines and the like is well known in many industries. For example, in the field of transporting crude or diluted bitumen by pipeline from tar sands extraction to a storage facility or refinery, the internal cylindrical surface of the metal pipe segments (each segment being typically 50 feet in length) that comprise the pipeline are often lined with a lining material comprised of a layer of a rubber compound (usually about 0.25 inches thick) that is adhered to the metal on the inside of the pipe, followed by a urethane layer (usually about 0.75 inches thick) that is adhered to the rubber layer. In other applications, the lining material may vary in thickness, composition or in other aspects. The lining material of the pipelines wears or deteriorates over time, and it becomes necessary to periodically remove and replace the affected pipe segments in the pipeline. It would be advantageous to be able to efficiently remove the worn lining material from the affected pipe segment so that it can be remanufactured with a replacement lining or reused as an unlined pipe segment in other applications.

As another example, the use of refractory as a lining material to line conduits, risers, boilers, cyclones, kilns, and the like is well known and essential in many industries. For instance, in the art of fluid catalytic conversion (FCC) of hydrocarbons to produce petroleum products, refractory protects the walls of reactor risers from the extreme temperatures required to crack the hydrocarbon feedstocks. Because refractory cokes, the working life-time of refractory is limited. Once coking becomes severe it is necessary to remove the coked refractory and replace it with fresh material. Failure to do so results in poor riser hydrodynamics, which causes sub-optimal, inadequate fuel and catalyst mixing. The ultimate result is decreased hydrocarbon conversion and product yield, which increases the price of the petroleum products to consumers. Currently, removing coked refractory from a lined structure is an arduous and expensive process for it must be done manually. The material is chipped away by hammers and chisels, and it may take as many as twenty shifts in order to remove coked refractory from a refinery riser. Given that such a refinery may be producing millions of dollars of product per day, the costs of down time for refractory removal also adds significantly to the cost of petroleum products.

Consequently, a system and a method are needed to quickly and efficiently remove lining material from lined structures such as pipe segments and refractory lined structures mentioned above, as well as from other lined structures.

### SUMMARY OF THE INVENTION

The present invention provides such a system and method that employs hydro-demolition techniques and novel equipment in order to exploit the power of hydro-demolition.

In order to address some of the shortcomings in the prior art, some aspects of the present invention provide an apparatus for the removal of lining material from the inside surface of a cylindrical structure, the apparatus comprising: a locating assembly (also referred to herein as a traveler) adapted to being received within the structure and being moved along the length of the structure, the traveler including a securing assembly that secures the traveler within the structure in a manner that allows the traveler to be intentionally moved by an operator; a rotatable nozzle assembly defining an axis of rotation and being connected to the traveler, the nozzle assembly comprising one or more nozzle lines each terminating in a nozzle head that rotates about the axis of rotation, the nozzle assembly being configured in a manner that each nozzle head is suitably spaced from the lining material to be able to deliver a jet of fluid under pressure to the lining material; a nozzle rotation means for rotating the nozzle assembly; and a conduit means in fluid communication with the nozzle assembly suitable for delivering a flow of fluid to the nozzle assembly under sufficient pressure to cut the lining material lining the structure.

In some embodiments, the nozzle assembly may be connected to the traveler in a manner that the axis of rotation of the nozzle assembly is approximately coincident with a central axis defined by the structure.

In some embodiments, the securing assembly may comprise one or more engagement members for contacting the inside surface of the structure or the lining material, and an extension means cooperating with each engagement member to provide a biasing force to the engagement member towards such contact.

In some embodiments, the traveler may comprise a frame having at least three engagement members radiating outward from the frame in a manner to position the frame centrally within the structure, and the nozzle assembly being connected to the frame in a manner that the axis of rotation of the nozzle assembly is approximately coincident with the central axis defined by the structure.

In some embodiments, each engagement member may comprise a wheel assembly having a wheel configured to roll along the lining material as the apparatus is moved within the structure by an operator. The wheel assembly may comprise at least two spaced apart wheels configured to simultaneously roll along the lining material as the apparatus is moved within the structure.

In some embodiments, each engagement member may comprise a skid configured to slide along the lining material as the apparatus is moved within the structure by an operator.

In some embodiments, each nozzle head of the nozzle assembly may be approximately equidistant from the axis of rotation

In some embodiments, the rotation means may be any one or a combination of the following: an exchanger that is powered by pressurized liquid or gas; an electric motor; a pneumatic motor; and a hydraulic motor.

In some embodiments, each extension means may be any one or a combination of the following: a spring; a hydraulic extender; and a pneumatic extender.

In some aspects, the present invention further provides a method for removing lining material from the inside surface of a cylindrical structure, the method comprising the steps of: providing an apparatus in accordance with any of the embodiments described herein; placing the apparatus in the structure so that the axis of rotation of the nozzle assembly is approximately coincident with the central axis defined by the structure; applying fluid at a high pressure to the nozzle assembly through the conduit means whereby high pressure jets of the fluid are forced against the lining material through the nozzle heads; and moving the traveler over the lining material in order to cut the lining material with the high pressure jets.

In some embodiments, fluid is water at pressures in the range of 20,000 p.s.i. and 40,000 p.s.i.

In some aspects, the present invention further provides a method of removing lining material from the inside surface of a lined structure, the method comprising the steps of: providing a rotating nozzle assembly within the lined structure, wherein the nozzle assembly defines an axis of rotation and comprises one or more nozzle lines each terminating in a nozzle head that rotates about the axis of rotation, the nozzle assembly being configured in a manner that each nozzle head is suitably spaced from the lining material to be able to deliver a jet of fluid under pressure to the lining material; providing a source of high pressure fluid in communication with the nozzle assembly; applying high pressure fluid to the nozzle assembly such that high pressure jets of the fluid are forced against the lining material through the nozzle heads to remove the lining material adjacent the nozzle heads; and moving the nozzle assembly over the lining material in order to cut the lining material with the high pressure jets. The fluid may be water at pressures in the range of 20,000 p.s.i. and 40,000 p.s.i.

In some embodiments, the methods may further include the step of providing an extension at a terminal end of the structure wherein the extension is adapted to permit the traveler to continue to move within the extension even after the traveler has been moved out of the structure so as to maintain an operative orientation of the nozzle assembly for a distance sufficient to enable the lining material to be removed up to the terminal end of the structure.

### BRIEF DESCRIPTION OF THE DRAWINGS

For a better understanding of the present invention and to show more clearly how it may be carried into effect, reference is made by way of example to the accompanying drawings in which:

FIG. 1 is a cross-sectional view of an embodiment of an apparatus in accordance with the present invention within a cylindrical lined structure in which the lining material has been partially removed;

FIG. 2 is a side view looking into an end of the lined structure showing the apparatus of FIG. 1 in the horizontally oriented lined structure, wherein the lining material and lined structure appear as concentric rings about a central axis; and

FIG. 3 is a cross-sectional view of another embodiment of an apparatus in accordance with the present invention within a cylindrical lined structure in which the lining material has been partially removed.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

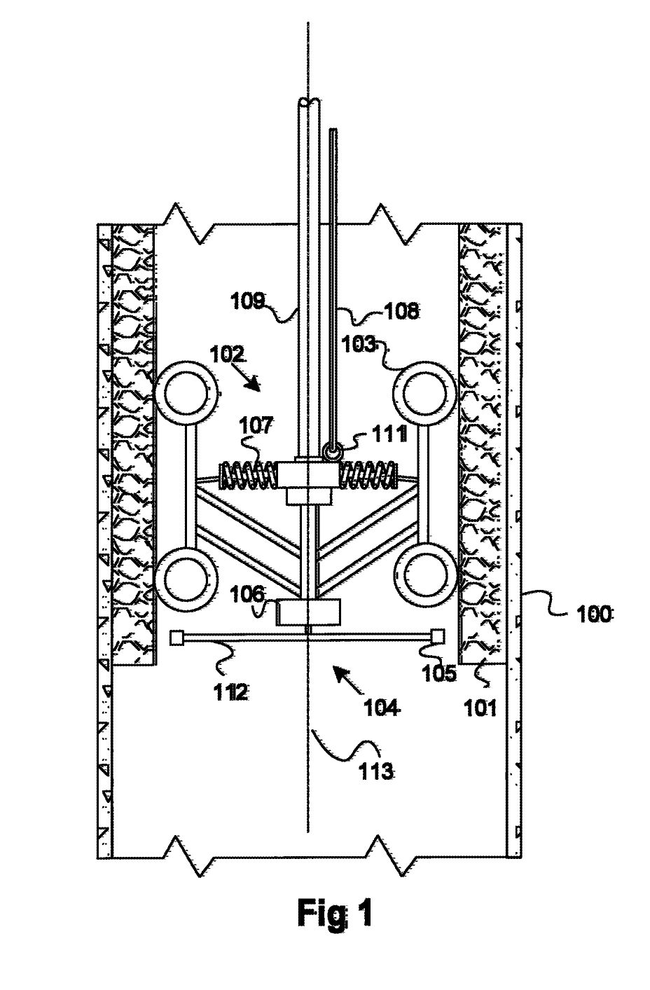

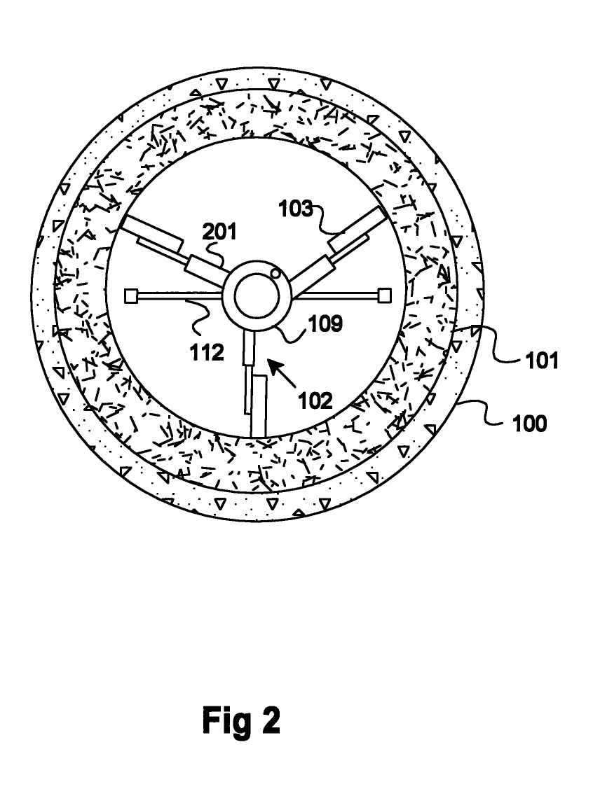

With reference to the figures, FIG. 1 is a cross-sectional view a cylindrical lined structure 100, with the lining material 101 partially removed. FIG. 2 is a side view looking inward into the horizontally oriented lined structure 100, wherein the lining material 101 and lined structure 100 appear as concentric rings about a central axis 113 (shown in FIG. 1). By way of example, the lined structure 100 may be a pipe segment from a pipeline, a riser, a boiler, a cyclone, a kiln or other structure having an inside cylindrical surface provided with a lining material. Examples of lining material may include rubber, urethane, refractory, or other material provided on the inside surface of a structure, in one or more layers, and which may be removed by hydro-demolition techniques. The scope of the invention goes beyond pipe segments to include any type or manner of lined structures.

The system of the invention includes a rotating nozzle assembly 104 that comprises one or more rigid nozzle lines 112 connected to nozzle heads 105. The nozzle assembly is caused to rotate about an axis of rotation by a nozzle rotation means 106. The axis may be approximately coincident or co-extensive with a central axis 113 of the lined structure. The rotation means may be an exchanger that is powered by pressurized liquid or gas; it may be an electric motor, pneumatic motor, or hydraulic motor.

The nozzle assembly and rotation means are carried on a locating assembly such as traveler 102. One function of the traveler is to locate the nozzle assembly within the lined structure and allow the nozzle assembly to ride within the lined structure, preferably along the central axis 113, and thereby keep the nozzle heads 105 properly spaced from the lining material 100 in order to deliver an optimum jet of fluid under sufficient pressure to cut the lining material. The fluid, which is normally water, is delivered to the nozzle assembly by a conduit means 109, which may be a pipe or a hose.

FIG. 2 shows how the traveler 102 comprises a chassis or frame having engagement members such as wheels 103 attached thereto. In the embodiment shown, three sets of wheel assemblies are employed. The wheel assemblies are positioned at approximately 120° intervals about the inner circumference of the lined structure 100. In this way, the center of the traveler, particularly the axis of rotation of the nozzle assembly 104, can be maintained approximately coincident with the lined structure axis 113 such that the nozzle heads do not impact with the lining material as they rotate and the jet of fluid emitted from each nozzle head is operative to remove the lining material throughout its range of rotation. The number of wheel assemblies can vary depending on the shape of the lined structure so long as there are at least a sufficient number to keep the traveler, particularly the nozzle assembly 104, approximately centered in the lined structure.

The wheel assemblies may comprise one or more wheels, chassis members, and an extension means, which forces the wheels against the lining material. In FIG. 1, spring 107 acts as the extension means by putting pressure against the wheels, forcing them against the lining material. Other devices for effectuating the extension means include hydraulic and pneumatic extenders or shock-absorber devices 201 such as shown in FIG. 2. Accordingly, the wheel assemblies together with the extension means provides an embodiment of a securing means on the traveler that secures the traveler within the structure in a manner that allows the traveler to be intentionally moved by an operator. In FIGS. 1 and 2, the wheels 103 of the traveler are pressed against the lining material, thereby keeping the traveler centered in the riser. Nozzle line 112 and nozzle head 105 express high pressure fluid supplied by conduit 109. An attachment means 108 such as a rod or cable holds the traveler at the appropriate position within the lined structure and enables it to be moved along the length of the lined structure.

In a vertically oriented lined structure, the traveler can be conveniently suspended in the lined structure and moved up and down by the attachment means 108 such as a suspension line or cable connected to a hoist (not shown). The suspension line is attached to an attachment member such as an eye 111 or other attachment point on the traveler. In a horizontally oriented lined structure, the traveler can be conveniently located in the lined structure and moved sideways by the attachment means 108 such as a cable or a rod connected to a drum or other horizontal movement means (not shown). Using a rigid attachment means 108 such as a rod enables the traveler to be moved horizontally in both directions.

A method of using the system to remove lining material from an lined structure includes the steps of: 1) providing the system; 2) placing the system in the lined structure so that the center of rotation of the nozzle assembly 104 is approximately coincident with the central axis 113; 3) applying fluid at a high pressure to the nozzle assembly through the conduit 109 whereby high pressure jets of the fluid are forced against the lining material 101 through the nozzles 105; and 4) moving the traveler 102 over the lining material in order to cut the lining material with the high pressure jets. The pressure of the fluid will vary according to the thickness and quality of the lining material. Generally, a pressure in the range of 20,000 p.s.i. and 40,000 p.s.i. is sufficient. In situations in which the lined structure is vertical it will be preferred to begin the process at the bottom of the lined structure and move the traveler upwards. In situations in which the lined structure is horizontal it may be preferred to begin the process at the far end of the lined structure and move the traveler sideways towards the near end. However, in some cases it may be necessary to move the rotating nozzles back and forth multiple times over a given length of lining material, in which case a more rigid attachment means 108 such as a rod may be more suited than a line or cable to moving the traveler in both directions.

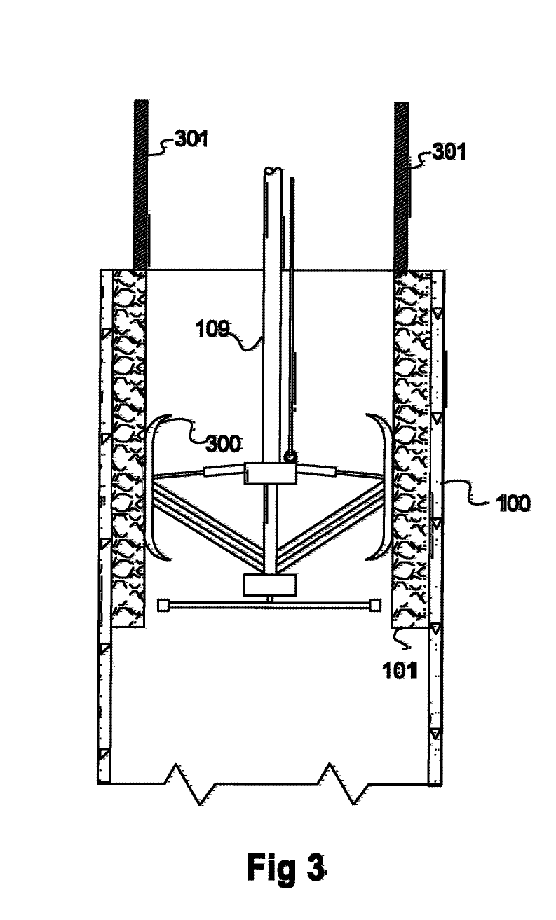

FIG. 3 shows another embodiment of the apparatus in accordance with the present invention. FIG. 3 shows a near end of the lined structure 100 with the traveler 102 just about to complete the removal of the lining material. The traveler 102 in this embodiment has engagement members that comprise skids 300 instead of wheels. Accordingly, the skids together with the extension means provides another embodiment of a securing means on the traveler that secures the traveler within the structure in a manner that allows the traveler to be intentionally moved by an operator. The skids 300 have the advantage of reducing the number of moving parts of the invention. The traveler could employ a combination of skids and wheels.

Also shown in FIG. 3 are structure extensions 301 that may be attached to the lined structure and allow the traveler to maintain its orientation along axis 113 even after the traveler has been extracted from the lined structure. The skids or wheels merely travel along the structure extensions 301 beyond the near end of the lined structure.

The invention has been described here with respect to a particular, preferred embodiment. Those of skill in the art will recognize that the scope of the invention obviously extends beyond this particular embodiment. For instance, various forms and designs of travelers and different types of nozzle rotators will, upon reading this disclosure, be obvious to those of skill in the art for accomplishing the disclosed functions.

What is claimed is:

1. An apparatus for removing lining material from a cylindrical inside surface of a lined structure, the apparatus comprising:
a locating assembly adapted to being received within the structure and being moved along the length of the structure, the locating assembly including a securing assembly that secures the locating assembly within the structure in a manner that allows the locating assembly to be intentionally moved by an operator;
a rotatable nozzle assembly defining an axis of rotation and being connected to the locating assembly, the nozzle assembly comprising one or more nozzle lines each terminating in a nozzle head that rotates about the axis of rotation, the nozzle assembly being configured in a manner that each nozzle head is suitably spaced from the lining material to be able to deliver a jet of fluid under pressure to the lining material;
a nozzle rotation means for rotating the nozzle assembly; and
a conduit means in fluid communication with the nozzle assembly suitable for delivering a flow of fluid to the nozzle assembly under sufficient pressure to cut the lining material lining the structure.

2. The apparatus as claimed in claim 1 wherein the nozzle assembly is connected to the locating assembly in a manner that the axis of rotation of the nozzle assembly is approximately coincident with a central axis defined by the structure.

3. The apparatus as claimed in claim 2, wherein the securing assembly comprises one or more engagement members for contacting the inside surface of the structure or the lining material, and an extension mechanism cooperating with each engagement member to provide a biasing force to the engagement member towards such contact.

4. The apparatus as claimed in claim 3 wherein the locating assembly comprises a frame having at least three engagement members radiating outward from the frame in a manner to position the frame centrally within the structure, and the nozzle assembly being connected to the frame in a manner that the axis of rotation of the nozzle assembly is approximately coincident with the central axis defined by the structure.

5. The apparatus as claimed in claim 4 wherein each engagement member comprises a wheel assembly having a wheel configured to roll along the lining material as the apparatus is moved within the structure by an operator.

6. The apparatus as claimed in claim 5 wherein the wheel assembly comprises at least two spaced apart wheels configured to simultaneously roll along the lining material as the apparatus is moved within the structure.

7. The apparatus as claimed in claim 4 wherein each engagement member comprises a skid configured to slide along the lining material as the apparatus is moved within the structure by an operator.

8. The apparatus as claimed in claim 4 wherein each nozzle head of the nozzle assembly is approximately equidistant from the axis of rotation.

9. The apparatus as claimed in claim 3 wherein the rotation means comprises any one of the following:
(a) an exchanger that is powered by pressurized liquid or gas;
(b) an electric motor;
(c) a pneumatic motor; and
(d) a hydraulic motor.

10. The apparatus as claimed in claim 3 wherein each extension means comprises any one of the following:
(a) a spring;
(b) a hydraulic extender; and
(c) a pneumatic extender.

11. A method of removing lining material from the inside surface of a lined structure, the method comprising the steps of:
a. providing a rotating nozzle assembly within the lined structure, wherein the nozzle assembly defines an axis of rotation and comprises one or more nozzle lines each terminating in a nozzle head that rotates about the axis of rotation, the nozzle assembly being configured in a manner that each nozzle head is suitably spaced from the lining material to be able to deliver a jet of fluid under pressure to the lining material;
b. providing a source of high pressure fluid in communication with the nozzle assembly;
c. applying high pressure fluid to the nozzle assembly such that high pressure jets of the fluid are forced against the lining material through the nozzle heads to remove the lining material adjacent the nozzle heads; and
d. moving the nozzle assembly over the lining material in order to cut the lining material with the high pressure jets.

12. The method as claimed in claim 11 further comprising the step of locating the nozzle assembly in the lined structure so that the axis of rotation of the nozzle assembly is approximately coincident with the central axis defined by the structure.

13. The method as claimed in claim 12 wherein the fluid is water at pressures in the range of 20,000 p.s.i. and 40,000 p.s.i.
